(19) United States
(12) Patent Application Publication
(10) Pub. No.: US 2014/0300527 A1
(43) Pub. Date: Oct. 9, 2014

(54) Antenna for Wireless Communication Device

(71) Applicant: RALINK TECHNOLOGY CORP., Hsinchu County (TW)

(72) Inventors: Shao-Chin Lo, Miaoli County (TW); Cheng-Hao Kuo, Hualien County (TW)

(73) Assignee: RALINK TECHNOLOGY CORP., Hsinchu County (TW)

(21) Appl. No.: 13/855,736

(22) Filed: Apr. 3, 2013

(51) Int. Cl. H01Q 1/12

(52) U.S. Cl. CPC H01Q 1/1207
USPC 343/882; 343/878

(57) ABSTRACT

The present invention discloses an antenna for a wireless communication device, including a radiator including a first fixing segment, and a first connecting unit including a first fixture unit and a second fixture unit for holding the first fixing segment such that the radiator is electrically connect to a circuit.

### BACKGROUND OF THE INVENTION

1. Field of the Invention

The present invention relates to an antenna for a wireless communication device, and more particularly, to an antenna having a replaceable radiator.

2. Description of the Prior Art

Wireless communication devices, such as a mobile phone, personal digital assistants (PDA), and wireless USB dongle, have become more and more popular and widely used in daily life. Also, the manufacture process of the wireless communication device is simplified to decrease the cost and enhance the productivity.

In general, different assembling methods are suitable for antennas of different types. For example, a printed antenna may be printed on a printed circuit board (PCB) of the wireless communication device, and an antenna made of bending metal may be assembled on the PCB through an automatic Surface Mount Technology (SMT) procedure. However, when replacement of the antenna is required for changing an operating frequency or fixing a defect of the antenna, the PCB with the printed antenna has to be abandoned and replaced by a new printed antenna, which wastes cost on the PCB and electronic elements thereof. On the other hand, the metal antenna can be removed from the PCB by de- soldering to re-solder a new metal antenna, which causes instability of antenna characteristics.

Thus, the traditional method of replacing an assembled antenna either brings extra cost or the risk of unpredictable antenna characteristics. In order to reduce production cost of the communication device and reach stable/predictable antenna characteristics, there is a need to improve the prior art.

### SUMMARY OF THE INVENTION

It is an object of the present invention to provide an antenna for a wireless communication device for easily replacing a radiator of the antenna.

The present invention discloses an antenna for a wireless communication device, including a first connecting unit, electrically connected to a circuit, including a first fixture unit, a second fixture unit and a mounting pad electrically connected between the first fixture unit and the second fixture unit, and a radiator including a first fixing segment capable of being fixed to the first and the second fixture units of the first connecting unit by inserting the first fixing segment between the first and the second fixture unit, to communicate with the RF signal generator via the first connecting unit.

The present invention further discloses a communication device, including a signal generator, and an antenna including a radiator including a first fixing segment, and a first connecting unit including a first fixture unit and a second fixture unit for holding the first fixing segment such that the radiator is electrically connect to the signal generator.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication device according to an embodiment of the present invention.

FIG. 2A and 2B are schematic diagrams of the antenna in FIG. 1 corresponding to different connecting units.

FIG. 3 is a schematic diagram of an antenna according to an embodiment of the present invention.

FIG. 4 is a schematic diagram of the antenna in FIG. 3 including an auxiliary connecting unit.

FIG. 5 is a schematic diagram of the antenna in FIG. 3 according to an embodiment of the present invention.

FIG. 6 is a schematic diagram of the antenna in FIG. 3 according to an embodiment of the present invention.

FIG. 7 is a schematic diagram of the antenna in FIG. 3 according to an embodiment of the present invention.

FIG. 8 is a schematic diagram of an antenna according to an embodiment of the present invention.

FIG. 9 is a schematic diagram of an antenna according to an embodiment of the present invention.

FIG. 10 is a schematic diagram of an antenna according to an embodiment of the present invention.

FIG. 11 is a schematic diagram of an assembly process of the antenna according to an embodiment of the present invention.

FIG. 12 is a schematic diagram of an RF signal testing process of the antenna according to an embodiment of the present invention.

### DETAILED DESCRIPTION

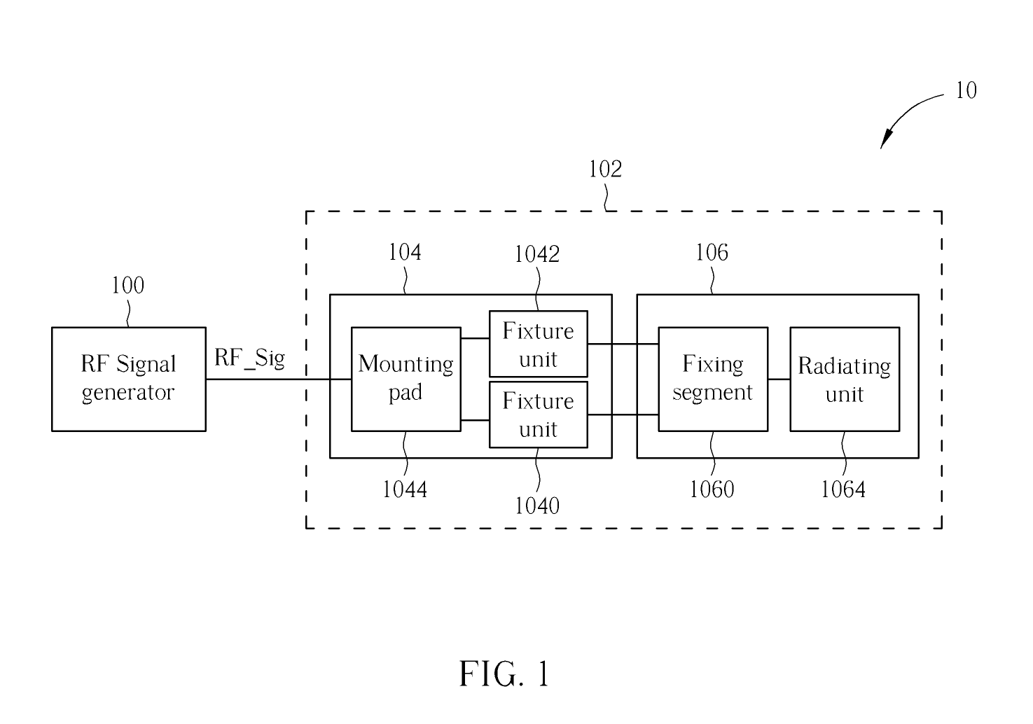

Please refer to FIG. 1, which is a functional block diagram of a wireless communication device 10 according to an embodiment of the present invention. The wireless communication device 10 may be a mobile phone, laptop, access point, a wireless USB dongle, or other electronic devices with wireless communication functionality. The wireless communication device 10 is simply composed of a circuit and an antenna 102. The circuit can be a radio-frequency (RF) signal generator 100 as shown in FIG. 1. The RF signal generator 100 is used for generating an RF signal RF_Sig. The antenna 102 includes a connecting unit 104 and a radiator 106. The connecting unit 104 includes fixture units 1040 and 1042 and a mounting pad 1044, and the radiator 106 includes a fixing segment 1060 and a radiating unit 1064. The mounting pad 1044 is electrically connected between the fixture units 1040 and 1042, and the mounting pad is used as a medium to connect fixture units 1040 and 1042 such that the connecting unit can be viewed as a clipper to clip the radiator 106. The radiator 106 utilizes the fixing segment 1060 to be fixed to the connecting unit 104 by inserting the fixing segment 1060 into the fixture units 1040 and 1042, such that the radiator 106 is capable of communicating with the RF signal generator 100 via the connecting unit 104.

In short, through inserting the fixing segment 1060 of the radiator 106 into the fixture units 1040 and 1042 of the connecting unit 104, the radiator 106 can be fixed and is capable of communicating with the RF signal generator 100 via the connecting unit 104.

Noticeably, the fixing segment 1060 is not only capable of being inserted into the fixture unit 1040, but also capable of being pulled out from the fixture unit 1040, to separate the radiator 106 from the connecting unit 104, and thus the radiator 106 is replaceable.

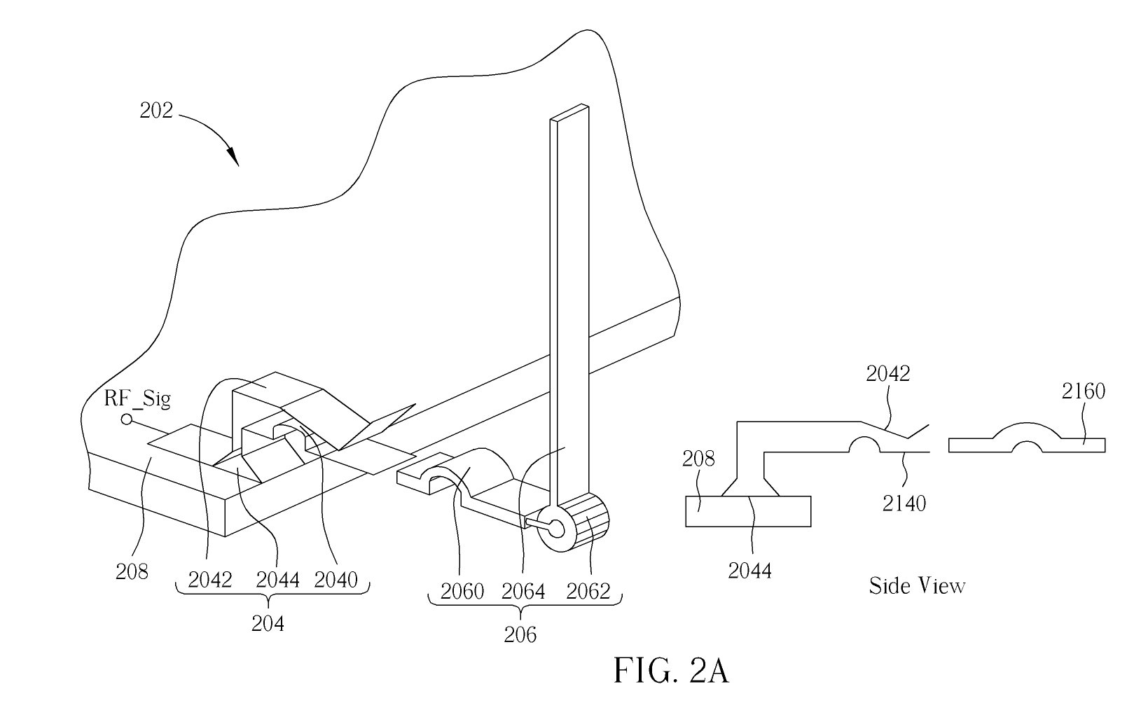

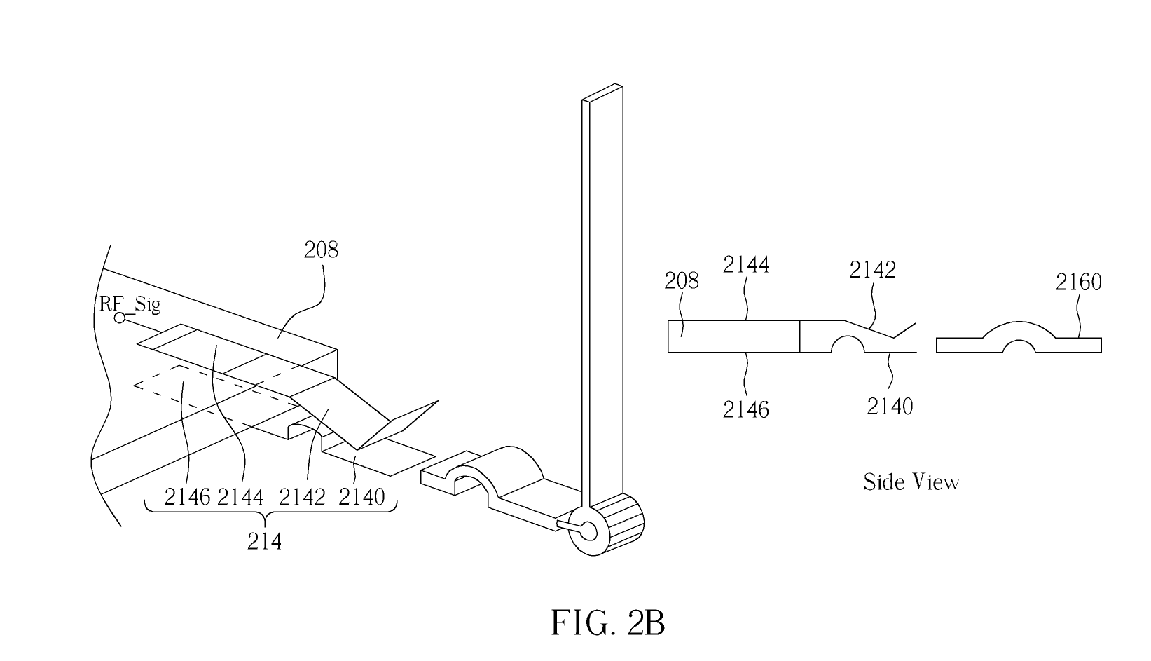

Specifically, please refer to FIG. 2A, which is a schematic diagram of an antenna 202 according to an embodiment of the present invention. The antenna 202 includes a connecting unit 204 and a radiator 206. The RF signal generator 100, i.e. the circuit, includes a printed circuit board (PCB) 208 for disposing the connecting unit 204 and the radiator 206. As shown in FIG. 2A, the antenna 202 is a monopole antenna since the radiator 206 of the antenna 202 is made of a metal bar, and the radiator 206 includes a fixing segment 2060, a pivot 2062 and a radiating unit 2064. The radiating unit 2064 is used for radiating the RF signal RF_Sig. The pivot 2062 is electrically connected between the fixing segment 2060 and the radiating unit 2064, such that the radiating unit 2064 is rotatable to adjust a radiating direction of the antenna 202. The connecting unit 204 is disposed on the PCB 208 to receive the RF signal RF_Sig generated by the RF signal generator 100. The connecting unit 204 is made of a bending metal as a clipper to clip the radiator 206. In detail, the connecting unit 204 includes fixture units 2040 and 2042 and a mounting pad 2044. The mounting pad 2044 is electrically connected between the fixture units 2040 and 2042, and is used for providing a soldering area such that the connecting unit 204 can be mounted and electrically fixed on the PCB 208 via soldering the mounting pad 2044 with the PCB 208. The fixture unit 2040 has an arc corresponding to an arc of the fixing segment 2060, and the fixture unit 2042 conforms to a V-shape, wherein a valley of the V-shape has the minimum gap to the fixture unit 2040 to provide a clipping force toward the fixture unit 2040, such that the radiator 206 is clipped and fixed after the fixing segment 2060 is inserted between the fixture units 2040 and 2042.

On the other hand, when replacement of the radiator 206 is required, e.g. replacing a radiator with a longer/shorter length to reach a lower/higher operating frequency, the replacement procedure may be simply achieved by pulling out the radiator 206 from the connecting unit 204 and inserting a new radiator into the connecting unit 204. Therefore, comparing with the traditional method for replacing the antenna by abandoning the PCB on which the printed antenna is printed, or by de-soldering the antenna on the PCB, with the clipping structure of the connecting unit 204, the radiator 206 may be easily replaced with minimum cost and less risk of unpredictable antenna characteristics since the PCB is kept unchanged and no de-soldering process is required.

As can be seen, the embodiment of the present invention utilizes the connecting unit 204 to fix the radiator 206 of the antenna 202, and the radiator 206 is capable of communicating with the RF signal generator 100 via the connecting unit 204. Those skilled in the art may make modifications or alterations accordingly, and not limited to herein. For example, FIG. 2B illustrates a schematic diagram of a connecting unit 214, which can substitute for the connecting unit 204. The connecting unit 214 includes fixture units 2142 and 2140 and mounting pads 2144 and 2146, the connecting unit 214 has a simpler structure and a lower profile than the connecting unit 204. As shown in FIG. 2B, the fixture units 2142 and 2140 are respectively disposed on a top layer and a bottom layer of the PCB 208 via soldering the mounting pad 2144 on the top layer and soldering the mounting pad 2146 on the bottom layer. As a result, once the radiator 206 is inserted into the connecting unit 214, the radiator 206 may be finely connected to the connecting unit 214.

Moreover, an amount of the connecting units is not limited. Additional connecting units may be added into the antenna 202 for different purposes, e.g. for electrically connecting the radiator 206 to a ground plane, or enhancing a robustness of the radiator 206 fixing with the connecting unit 204 to ensure the stability of antenna characteristics. In such a situation, with the additional connecting units, different antenna types, e.g. aPlanar Inverted-F Antenna (PIFA) and a loop antenna, may be feasible for the clipping structure of the present invention, and not limited to the monopole antenna 202 shown in FIG. 2A. Also, the shape of the connecting units may be modified to provide different methods of combing the fixture units and the fixing segments.

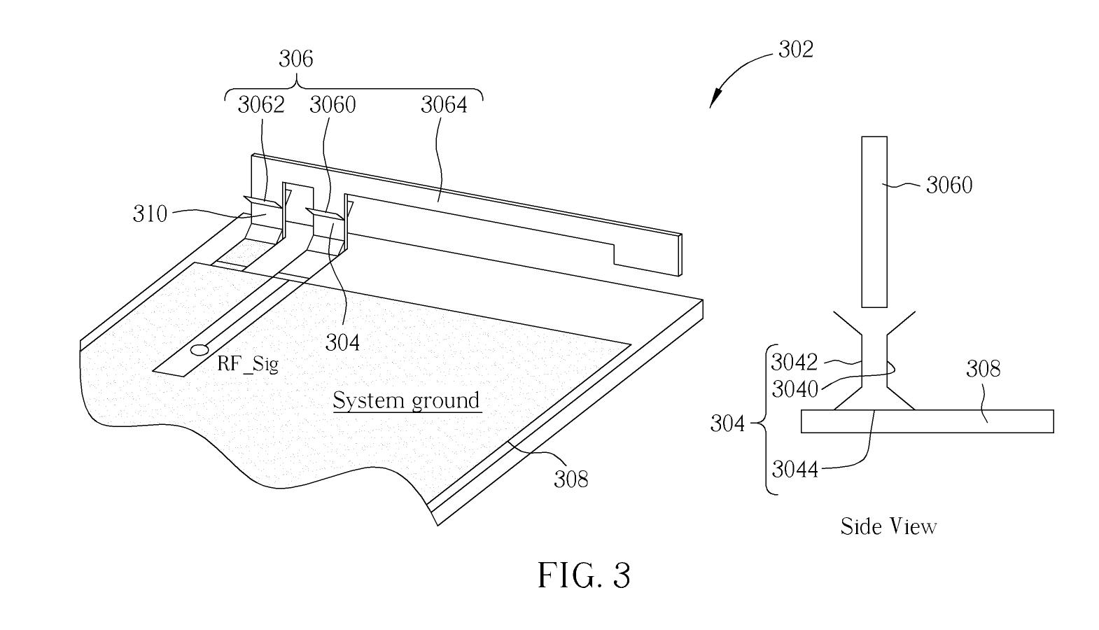

The following embodiments introduce examples of a PIFA with additional connecting units, and different shapes of the connecting units. Please refer to FIG. 3, which is a schematic diagram of an antenna 302 according to an embodiment of the present invention. The antenna 302 includes connecting units 304 and 310 and a radiator 306. The RF signal generator 100, i.e. the circuit, includes a PCB 308 for disposing the connecting units 304 and 310 and the radiator 3206. As well known in this art, a PIFA typically includes a short-circuit stub connected to a ground plane for compensating a capacitive input impedance of the PIFA due to the inverted-F structure. Hence, the connecting unit 310 plays a role of the short-circuit stub as a medium of connecting the radiator 306 to a system ground of the wireless communication device. The connecting units 304 and 310 are disposed on the PCB 308, wherein the connecting unit 304 is electrically connected to the RF signal generator 100 for receiving the RF signal RF_Sig, and the connecting unit 310 is electrically connected to the system ground of the wireless communication device 10. The connecting unit 304 includes a pair of fixture units 3040 and 3042, and a mounting pad 3044. The connecting unit 310 has an identical structure with the connecting unit 304. Take the connecting unit 304 for detailed description, the mounting pad 3044 is used for providing a soldering area such that the connecting unit 304 can be mounted and electrically fixed on the PCB 308 via soldering the mounting pad 3044 with the PCB 308. The fixture units 3040 and 3042 conform to a U-shape, bottoms of the U-shaped fixture units 3040 and 3042 are in parallel to provide a clipping force toward each other so as to sandwich the radiator 306. The radiator 306 includes fixing segments 3060 and 3062 and a radiating unit 3064, such that the radiator 306 is fixed by respectively inserting the fixing segments 3060 and 3062 between the pair of fixture units 3040 and 3042 and the pair of fixture units 3100 and 3102. As a result, the radiator 306 is capable of communicating with the RF signal generator 100 through the connecting unit 304 and has a grounding with the system ground of the wireless communication device 10 through the connecting unit 310, to achieve wireless signals transmission and reception.

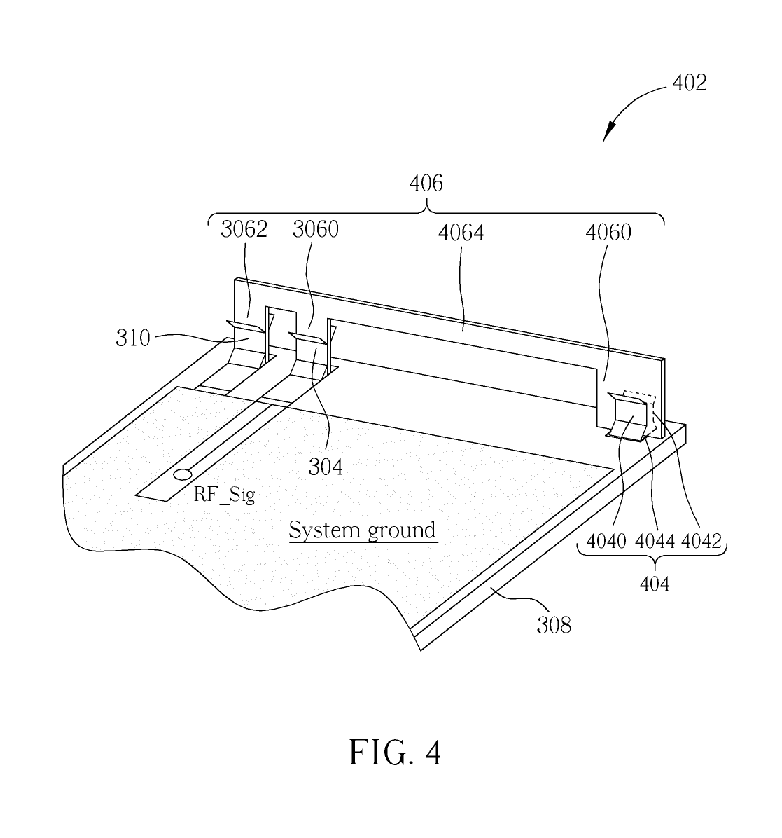

Please refer to FIG. 4, which is a schematic diagram of an antenna 402 including an auxiliary connecting unit 404. As shown in FIG. 4, the auxiliary connecting unit 404 is disposed on a pad of the PCB 308 isolated from the system ground of the communication device 10. The radiator 306 further includes a fixing segment 4060, and the auxiliary connecting unit 404 includes a pair of fixture units 4040 and 4042 and a mounting pad 4044. In such a structure, the fixing segment 4064 of the radiator 306 may be inserted between the pair of fixture units 4040 and 4042, to enhance the robustness of the radiator 406 fixing with the connecting unit 404. Noticeably, a plurality of the auxiliary connecting units may be added into the antenna 402 according to practical requirements, and the position disposing the auxiliary connecting unit 404 is adjustable as well. Or, the auxiliary connecting unit 404 maybe connected to the system ground of the communication device 10, such that the radiator 406 may have multiple groundings with the system ground. As a result, an antenna designer may have much flexibility to design the antenna.

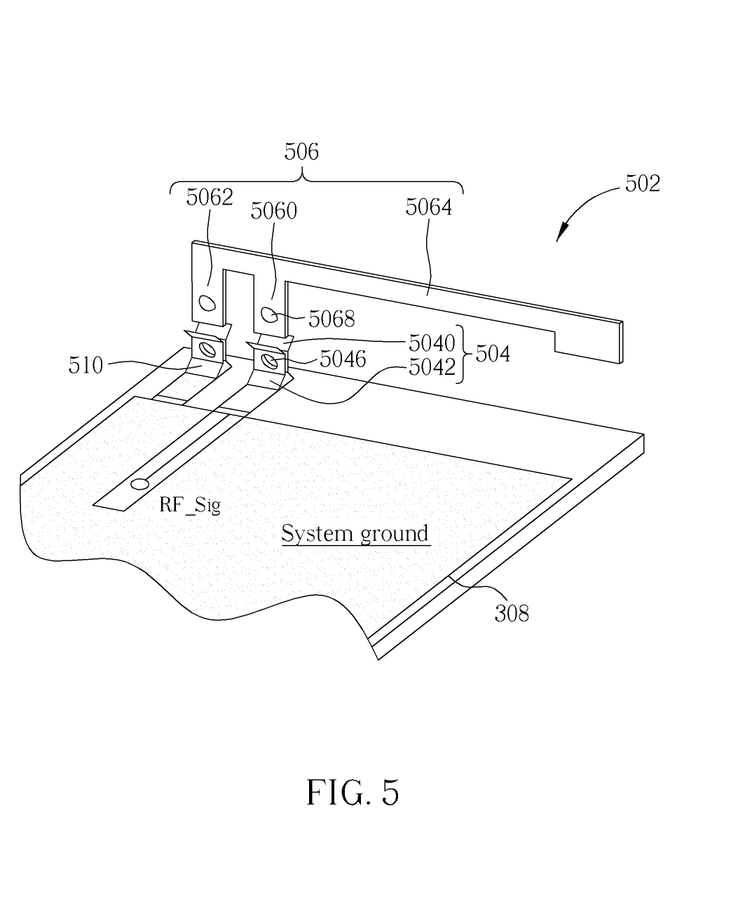

On the other hand, except adding the auxiliary connecting unit, changing the shape of the connecting units may be a feasible method to enhance the robustness of fixing the radiator. For example, please refer to FIG. 5 to FIG. 7, which illustrate the connecting units with different shapes. As shown in FIG. 5, a pair of fixture units 5040 and 5042 of a connecting unit 504 further include a hole 5046 corresponding to a knob 5068 of the fixing segment 5060. In such a structure, the knob 5068 may be fitted into the hole 5046 when the fixing segment 5060 is inserted into the pair of fixture units 5040 and 5042, which enhances the accuracy of fixing the radiator 506 with connecting unit 504, i.e. the position where the radiator 506 is fixed with the connecting unit 504 may be more precise.

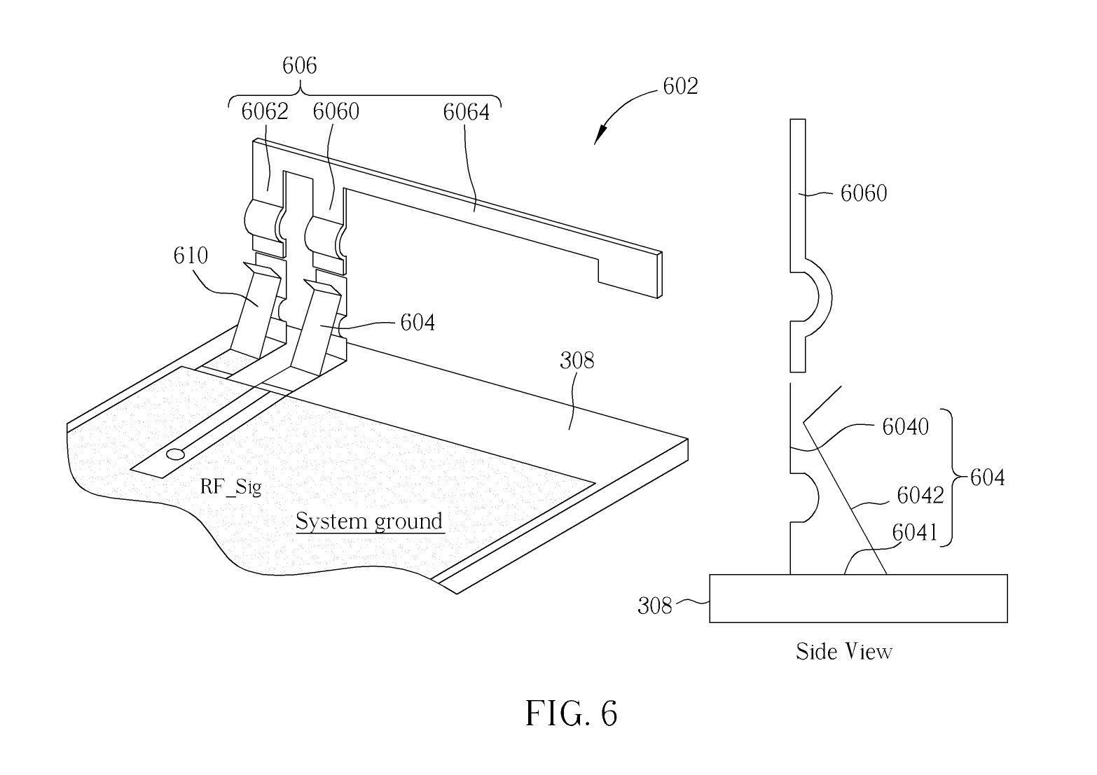

Noticeably, the structures of the connecting units 304, 404 and 504 are symmetric, i.e. the pair of fixture units 3040 and 3042 is identical. In comparison, as shown in FIG. 6, the structures of connecting units 604 and 610 are asymmetric. Specifically, as can be seen from the side view of the connecting unit 604, a fixture unit 6040 has an arc corresponding to an arc of a fixing segment 6060, and a fixture unit 6042 conforms to a V-shape. The valley of the V-shape has the minimum gap to the fixture unit 6040 to provide a clipping force toward the fixture unit 6040, such that the radiator 606 is clipped and fixed after the fixing segment 6060 is inserted between the fixture units 6040 and 6042. As a result, once the radiator 606 is inserted into the connecting unit 604, the radiator 606 may be finely connected to the connecting unit 604.

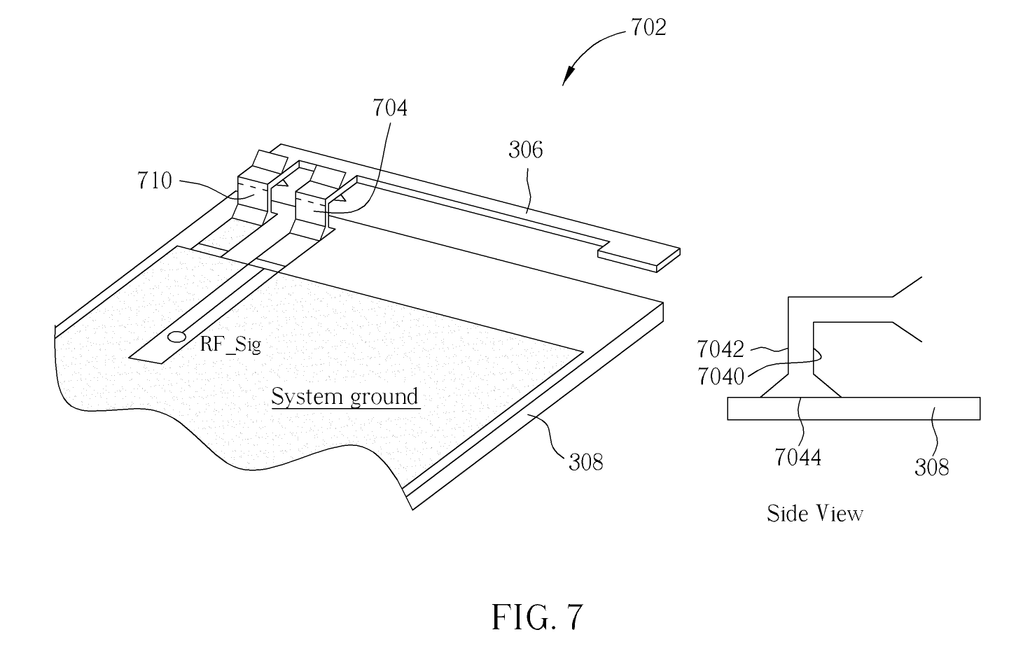

Besides, the structure of the connecting unit 604 is similar to that of the connecting unit 204 shown in FIGS. 2A, one difference between the connecting units 604 and 204 is that the fixture units 2040 and 2042 of the connecting unit 204 are bent with 90 degrees, such that the radiator 206 is inserted along a horizontal direction, while the radiator 306 is inserted along a vertical direction. Please refer to FIG. 7, which illustrates a bent connecting unit 704. The connecting unit 704 is similar to the connecting unit 304, the bent structure allows the radiator 306 to be inserted into the connecting unit 704 along the horizontal direction. For broadening the flexibility of designing the connecting unit, the connecting unit 704 may be bent with multiple angles, e.g. a pair of fixture units 7040 and 7042 are bent with a 90 degrees bending angle, and the bending angle of the pair of fixture units 7040 and 7042 may be adjustable as well. Therefore, the radiator 306 may be inserted into the connecting unit 704 from any direction according to practical requirements.

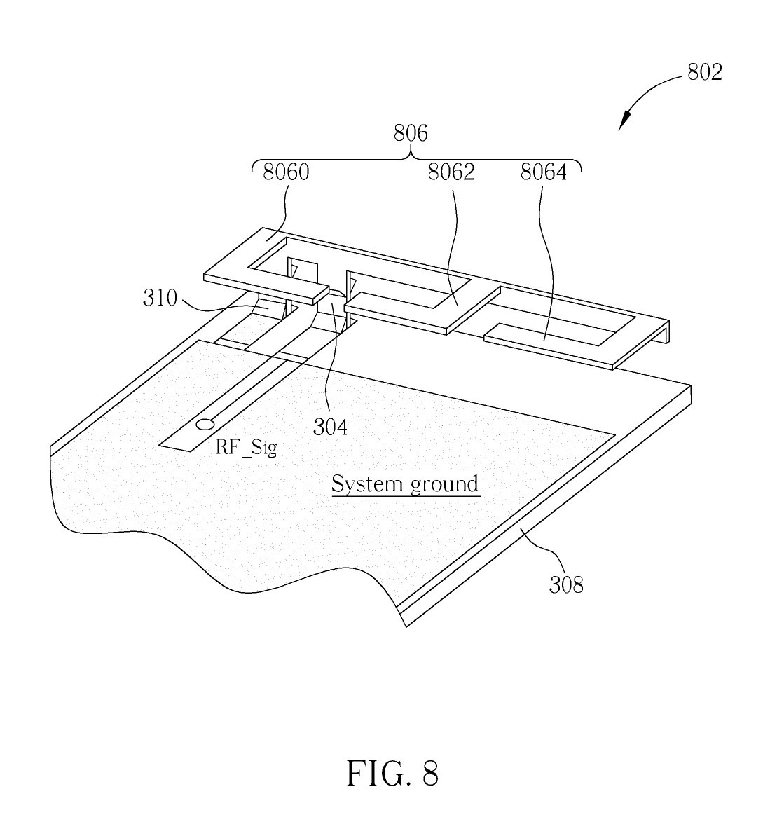

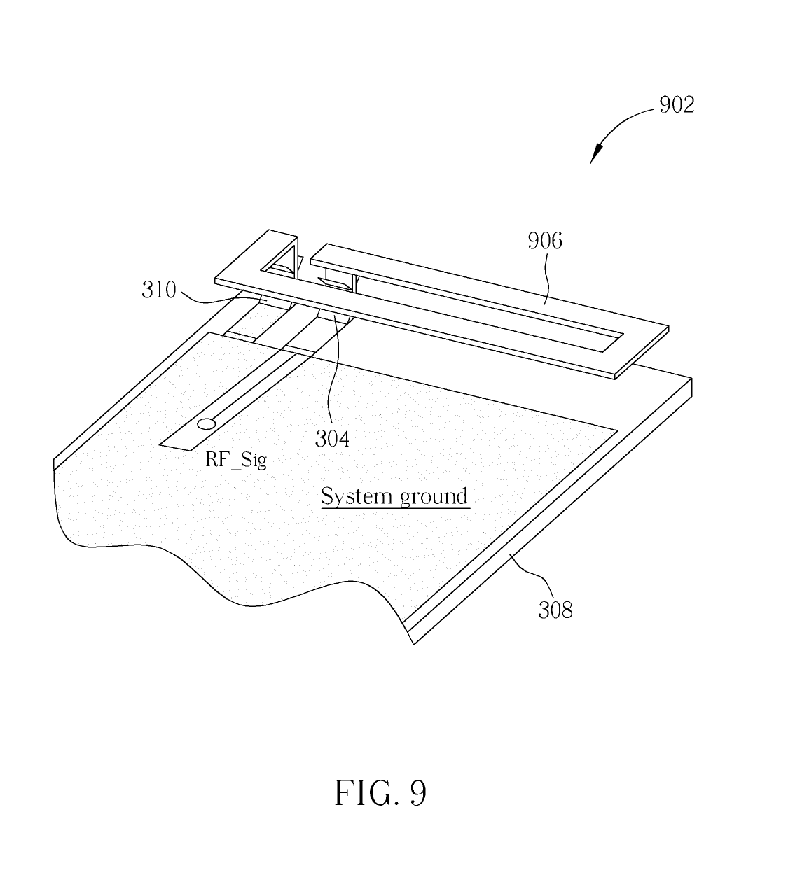

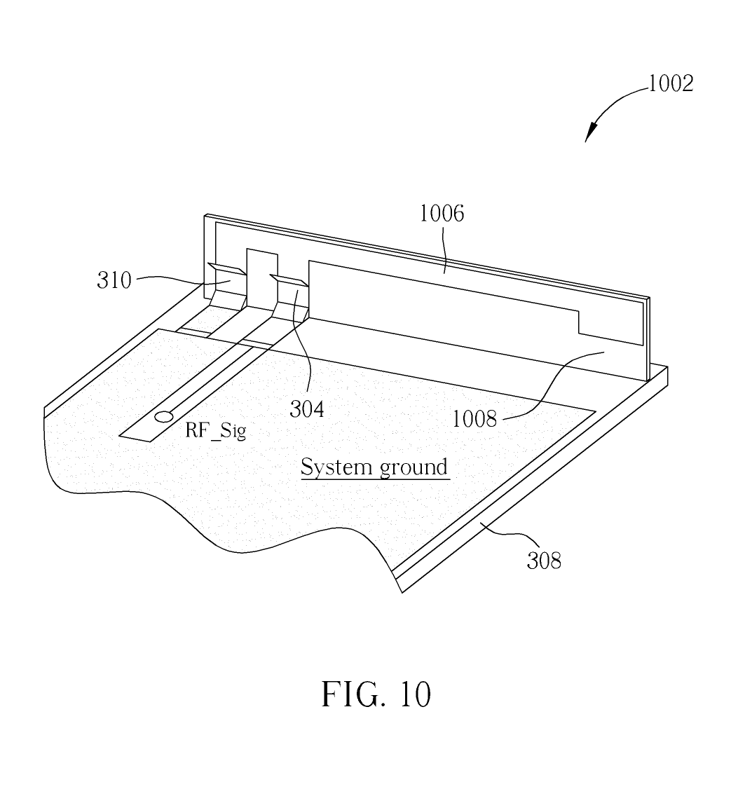

Furthermore, the shape of the radiator maybe modified to form antennas with different types. For example, please refer to FIG. 8, which is a schematic diagram of an antenna 802 according to an embodiment of the present invention. The radiator 806 of the antenna 802 includes branches 8060, 8062 and 8064, to form multiple current paths on the radiator 806, such that the antenna 802 is capable of operating in multiple frequency bands. FIG. 9 is a schematic diagram of an antenna 902 according to an embodiment of the present invention. The antenna 902 is a loop antenna, and the radiator 906 is extended from the connecting unit 304 to the connecting unit 310 to form a loop shape. Besides, materials of the antenna is not limited, the radiators shown in FIGS. 2A/B to FIG. 9 are made of bending metals, while FIG. 10 illustrates a printed antenna 1002 including a radiator 1006 printed on a PCB 1008.

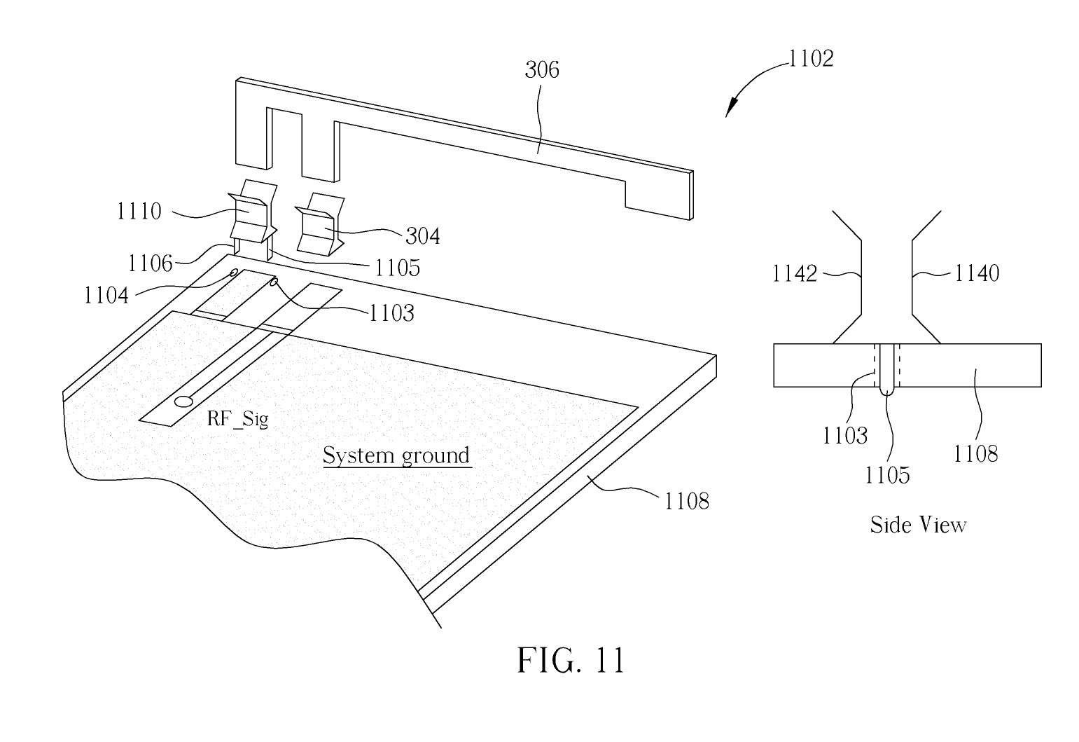

In addition, the present invention further introduces a method of assembling an antenna 1102. As for the method of assembling the antennas 202, 302, 402, 502, 602, 702, 802, 902 and 1002 are similar and omitted for simplicity. Please refer to FIG. 11, which is a schematic diagram of assembly steps of the antenna 1102 according to an embodiment of the present invention. The connecting unit 304 is preferably a Surface Mount Device (SMD) or a Dual In-line Package (DIP) element to be mounted on the PCB 308 through a Surface Mount Technology (SMT) procedure. For example, the connecting unit 304 shown in FIG. 11 is an SMD, the PCB 308 on which is reserved one pad for mounting the SMD connecting unit 304; the connecting unit 1110 shown in FIG. 11 is a DIP element and further includes two parallel connecting pins 1106 and 1105, and the PCB 1108 is reserved another pad for mounting the DIP connecting unit 1110 and two vias 1103 and 1104 for being fitted in the connecting pins 1105 and 1106. The radiator 306 can be inserted into the connecting units 304 and 310 after the connecting units 304 and 310 are well mounted on the PCB 308.

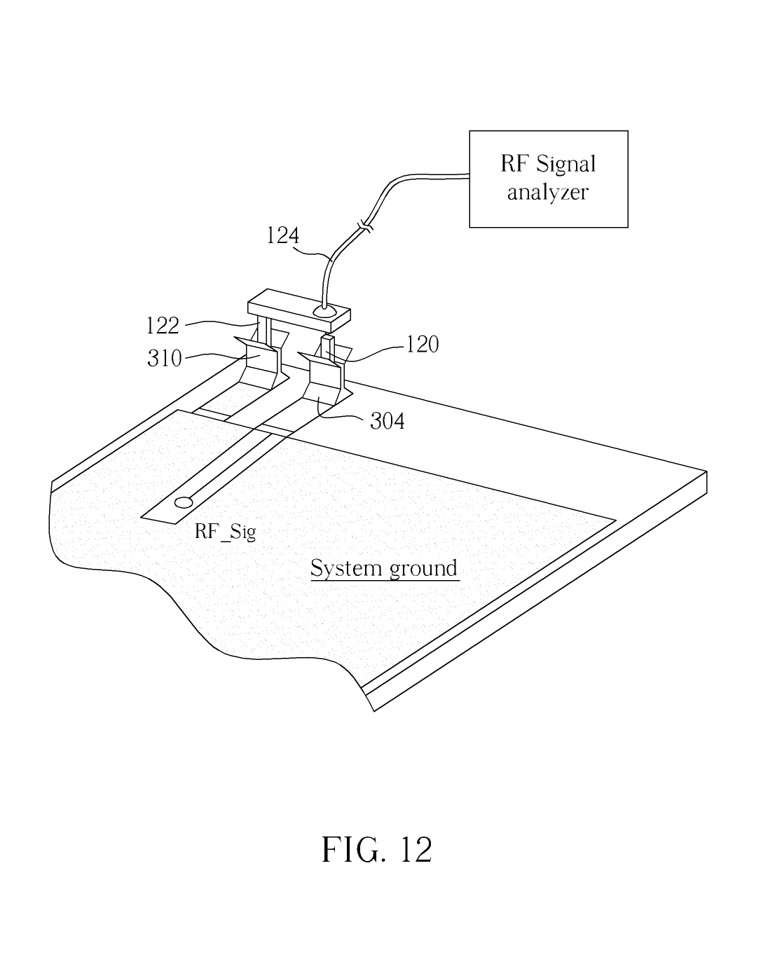

Noticeably, during the assembly process of the antenna, in order to ensure the RF signal RF_Sig can be well transmitted through the connecting units, it is necessary to test a signal intensity of the RF signal RF_Sig before the radiator is inserted into the connecting unit. Please refer to FIG. 12, which is a schematic diagram of testing the signal intensity of the RF signal RF_Sig. As shown in FIG. 12, a pogo pin device is inserted into the connecting units 304 and 310, and the pogo pin device includes a test pin 120, ground pin 122 and an RF cable 124. The test pin is inserted into the connecting unit 304, for measuring the signal intensity of the RF signal RF_Sig. The ground pin is inserted into the connecting unit 310 to obtain the same voltage level with the system ground. The RF cable 124 is a coaxial cable whose inner core is electrically connected to the test pin 120 and the inner core is covered by an outer shield electrically connected to the ground pin 122; therefore, the RF cable 124 is a transmission line capable of transmitting the RF signal RF_Sig to an RF signal analyzer for further signal analysis.

To sum up, the traditional method of replacing the antenna either brings extra cost or the risk of instable antenna characteristics. In comparison, the present invention utilizes the connecting units to fix the radiator of the antenna and the radiator is capable of communicating with the RF signal generator via the connecting unit. And the connecting unit has variety of functions not only for RF signal transmission but also for fixture and providing grounding. With the additional connecting units, different antenna types may be feasible, e.g. monopole, PIFA, loop and multi current paths antennas. Also, the present invention introduces different shapes of the connecting unit to provide different robustness of the connecting units fixing with the radiator. Moreover, the present invention further provides a method of testing the RF signal through the connecting units during the assembly process. As a result, the present invention provides the antenna designer much flexibility for designing the antenna and a promising solution for antenna production and replacement (repair) with minimum cost and stable antenna characteristics.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An antenna for a wireless communication device, comprising:
a radiator, comprising a first fixing segment; and
a first connecting unit, comprising a first fixture unit and a second fixture unit for holding the first fixing segment such that the radiator is electrically connect to a circuit.

2. The antenna of claim 1, further comprising a second connecting unit, electrically connected to a ground, comprising a third and a fourth fixture units, wherein the radiator further comprising a second fixing segment capable of being fixed to the third and fourth fixture units of the second connecting unit by inserting the second fixing segment into the third and fourth fixture units.

3. The antenna of claim 1, wherein the circuit comprises a printed circuit board (PCB) for disposing the first connecting unit and the radiator.

4. The antenna of claim 3, further comprising at least one auxiliary fixture unit, connected to the printed circuit board, wherein the radiator further comprising at least one auxiliary fixing segment capable of being fixed to the at least one auxiliary fixture unit by inserting the at least one auxiliary fixing segment into the at least one auxiliary fixture unit.

5. The antenna of claim 3, wherein the first fixture unit conforms to a V-shape, and the second fixture unit comprises an arc corresponding to an arc of the first fixing segment of the radiator.

6. The antenna of claim 5, wherein the first fixture unit is disposed on a first layer of the PCB, and the second fixture unit is disposed on a second layer of the PCB.

7. The antenna of claim 1, wherein the antenna is a monopole antenna.

8. The antenna of claim 7, further comprising:
a radiating unit; and
a pivot, coupled between the radiating unit and the first fixing segment, for rotating the radiating unit to change a radiating direction of the antenna.

9. The antenna of claim 1, wherein the first and second fixture units comprise a hole corresponding to a knob of the first fixing segment, the knob is fitted into the hole by inserting the fixing segment between the first and second fixture units.

10. The antenna of claim 2, wherein the antenna is a planar inverted-F antenna or a loop antenna.

11. The antenna of claim 2, wherein the radiator further comprises at least one branch.

12. The antenna of claim 11, wherein the antenna is an antenna with multiple current paths.

13. The antenna of claim 1, wherein the first connecting unit is a surface mount device (SMD) or a dual in-line package (DIP) device.

14. A communication device, comprising:
a signal generator; and
an antenna, comprising:
a radiator, comprising a first fixing segment; and
a first connecting unit, comprising a first fixture unit and a second fixture unit for holding the first fixing segment such that the radiator is electrically connect to the signal generator.

15. The communication device of claim 14, further comprising a second connecting unit, electrically connected to a ground, comprising a third and a fourth fixture units, wherein the radiator further comprising a second fixing segment capable of being fixed to the third and fourth fixture units of the second connecting unit by inserting the second fixing segment into the third and fourth fixture units.

16. The communication device of claim 14, wherein the circuit comprises a printed circuit board (PCB) for disposing the first connecting unit and the radiator.

17. The communication device of claim 16, further comprising at least one auxiliary fixture unit, connected to the printed circuit board, wherein the radiator further comprising at least one auxiliary fixing segment capable of being fixed to the at least one auxiliary fixture unit by inserting the at least one auxiliary fixing segment into the at least one auxiliary fixture unit.

18. The communication device of claim 16, wherein the first fixture unit conforms to a V-shape, and the second fixture unit comprises an arc corresponding to an arc of the first fixing segment of the radiator.

19. The communication device of claim 18, wherein the first fixture unit is disposed on a first layer of the PCB, and the second fixture unit is disposed on a second layer of the PCB.

20. The communication device of claim 14, wherein the antenna is a monopole antenna.

21. The communication device of claim 20, wherein the antenna further comprises:
a radiating unit; and
a pivot, coupled between the radiating unit and the first fixing segment, for rotating the radiating unit to change a radiating direction of the antenna.

22. The communication device of claim 14, wherein the first and second fixture units comprise a hole corresponding to a knob of the first fixing segment, the knob is fitted into the hole by inserting the fixing segment between the first and second fixture units.

23. The communication device of claim 15, wherein the antenna is a planar inverted-F antenna or a loop antenna.

24. The communication device of claim 15, wherein the radiator further comprises at least one branch.

25. The communication device of claim 24, wherein the antenna is an antenna with multiple current paths.

26. The communication device of claim 14, wherein the first connecting unit is a surface mount device (SMD) or a dual in-line package (DIP) device.
